(19) United States
(12) Patent Application Publication
(10) Pub. No.: US 2008/0288989 A1
(43) Pub. Date: Nov. 20, 2008

(54) System, Methods and Apparatus for Video Communications

(76) Inventors: Yu "Brian" Zheng, Walnut, CA (US); Kan Wang, Corona, CA (US); Calvin Chee Keung Lee, Walnut, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/748,428

(22) Filed: May 14, 2007

(51) Int. Cl. H04N 7/173

(52) U.S. Cl. 725/92

(57) ABSTRACT

A computer software product, methods and apparatus for improved video communications are provided. In one embodiment, an apparatus is provided that is configured to send v-mail messages. The v-mail messages contain a video stream that is stored on a second device on a network. In one embodiment, the second device is configured to associate multiple video streams to a thread and allow users access to stored video content and associated files. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention generally relates to video communications. More particularly, the invention concerns a system, methods, and apparatus for online video communications.

### BACKGROUND OF THE INVENTION

Modern communications systems have become commonplace in our society. From ecommerce to cell-phones to email communication networks have changed the way we live. With the advent of cellular telephones and the related infrastructure, communications have become more immediate. A communication user may be reached virtually anywhere at any time. Other forms of more immediate communications include instant messaging and text messaging.

Other forms of communications may include more of a time delay. With email a user may reply to an email when ever they wish. Email is limited with respect to the user's experience since it primarily contains text that a user reads. While it is true that most email systems additionally allow for attachments, such as files, these attachments may, or may not comprise the message being communicated. Forms of video communications exist where a user send video through the use of a camera. Most of these video communications platforms comprise relatively immediate communications in the form of “video chat”. For example, a number of commercial internet “messengers” include video. One limitation inherent in these messengers is the video content is not captured on either end of the conversation. In a situation where important discussions are occurring, there is no record of the substance of what transpired. Further, these messenger applications typically have no ability to playback or forward the video content to other interested parties.

In many contexts it would be useful to have a video-mail system which allows users to communicate more effectively. Therefore there exists a need for a system, methods, and apparatus for improved video communications.

### SUMMARY OF THE INVENTION

The present invention provides a system, apparatus and methods for overcoming some of the difficulties presented above. In an exemplary embodiment, a method of facilitating video communications is provided. In this embodiment, a first electronic device is configured to include a graphical user interface. In various embodiments, the graphical user interface may include a number of controls and input sections. One control present on the graphical user interface is a video control interface that allows a user to stream video to a second electronic device on the network. In this embodiment, the user interface additionally contains a recipient section allowing a user to designate a recipient of the video stream. Once the video is initiated, a camera connected to the electronic device is activated and video is streamed to a second device on the network. As further described below the second electronic device may be a server where the video is stored. Once the video has been transferred to the second device a notification is sent that the video has been stored.

In a another embodiment, a method is provided that allows a user to associate other electronic files to the video. In this embodiment, the user interface includes a control for selecting a file. When video is streamed to the server, the file is transferred to the server where it is associated to the video stream. Further embodiments provide for association of files to the video through a database. In an exemplary embodiment, the second electronic device associates a plurality of video streams to a thread. The thread may contain a series of video correspondences between users of electronic devices. Additionally, other items such as electronic files, audio and the like may be associated to the thread. One feature of this embodiment is that the thread may be transferred to an electronic device on the network where a user may select portions of the thread to view. Additionally, in some embodiments, controls are provided for a user may to forward a portion of the thread to another electronic device.

In a still further embodiment, an electronic device is provided. In this embodiment, the electronic device includes a video display device where a graphical user interface may be displayed. The graphical user interface consisting of at least a video control and an input section for designating a recipient of a video message. The electronic device having a connection to a camera suitable for streaming video to another electronic device on a network. In this embodiment, the device is configured to stream a video message to a second device where the second device stores the video message. The second device then sends a notification to the recipient indicating that the video has been stored and is available for viewing.

One feature of this embodiment is that it allows for a more persistent record of a video communication by storing the contents and related documents on an electronic device on a network where they can be later accessed. Further, by associating a plurality of videos to a thread a user may select a portion of the thread for viewing or forwarding to another device.

### BRIEF DESCRIPTION OF THE DRAWINGS

Various embodiments of the present invention taught herein are illustrated by way of example, and not by way of limitation, in the figures of the accompanying drawings, in which:

FIG. 1 Illustrates a communication network consistent with various embodiments;

FIG. 2 illustrates a client server communication network consistent with provided embodiments;

FIG. 3 illustrates an electronic device consistent with provided embodiments;

FIG. 4 illustrates another electronic device consistent with provided embodiments;

FIG. 5 illustrates a further electronic device and a computer software product consistent with provided embodiments;

FIG. 6 illustrates various advantages and features of the an enhanced video communication system;

FIG. 7 depicts the flow of one provided method of video communications;

FIG. 8 illustrates an exemplary embodiment of a graphical user interface;

FIG. 9 illustrates the flow of another provided method for video communications;

FIG. 10 illustrates another embodiment of a graphical user interface;

FIG. 11 depicts the flow of another provided method of video communications;

FIG. 12 is an exemplary illustration of features of various embodiments of video communications;

FIG. 13 illustrates the flow of another provided method of video communications;

FIG. 14 depicts the flow of a further provided method of video communications;

FIG. 15 illustrates another exemplary embodiment of a graphical user interface; and

FIG. 16 illustrates another exemplary embodiment of a provided graphical user interface.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Text based communications and to some extent voice based communications sometimes mask portions of a conversation. For example, in an email exchange or a cellular phone call a persons facial expressions are not apparent to the recipient. Video chat systems exist that overcome part of this limitation, but these programs are not persistent in their ability to store and later retrieve the video content. An object of the present invention is to provide a system, methods and apparatus that overcome some of these difficulties and provide a richer communication experience to the user. Additionally, since various embodiments provide for storage, association, and playback, the embodiments of the present invention are a significant improvement over existing communication technologies.

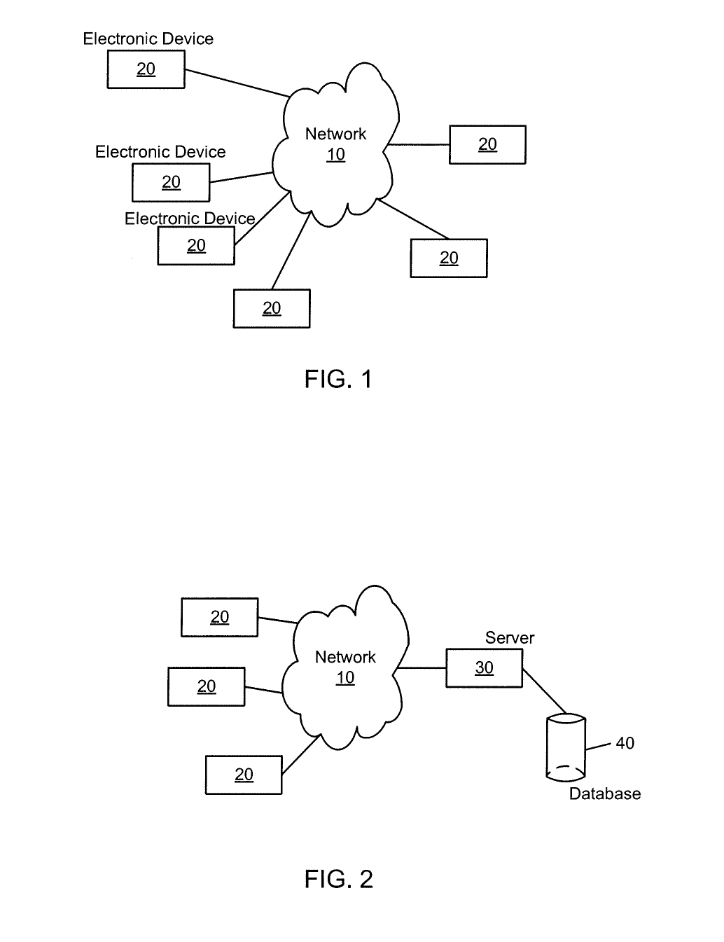

Various embodiments provide for video-centric communication between devices on a network. As illustrated in FIG. 1, a plurality of electronic devices 20 may be communicating through network 10. In one embodiment, network 10 is a peer-to-peer network where electronic devices 20 are peers communicating directly with each other across network 10. In another embodiment, illustrated in FIG. 2, one or more of electronic devices 20 may be a server 30. In this embodiment, network 10 may be considered a client-server network where communication between electronic devices 10 occurs through a server 30 on network 10. As further illustrated in FIG. 2, server 30 may be associated with a database 40 where communications and in various embodiments, files may be stored and associated with the video communications. In some embodiments, database 40 is located internally on server 30, in other embodiments it is located on another electronic device 20 on network 10.

As is known in the art, network 10 may employ wireless, wired, and optical media as the media for communication. Further, in some embodiments, portions of network 10 may comprise the Public Switched Telephone Network (PSTN). Networks, as used herein may be classified by range. For example, a local area networks, wide area networks, metropolitan area networks and personal area networks. Additionally, networks may be classified by communications media, such as wireless networks and optical networks for example. Further, some networks may contain portions in which multiple media are employed. For example, in modern television distribution networks, Hybrid-Fiber Coax networks are typically employed. In these networks, optical fiber is used from the “head end” out to distribution nodes in the field. At a distribution node communications content is mapped onto a coaxial media for distribution to a customer's premises. In many environments, the Internet is mapped into these Hybrid Fiber Coax networks providing high-speed Internet access to customer premises through a “cable-modem”. In these types of networks 10, electronic devices 20 may comprise computers, laptop computers, and servers 30 to name a few. Some portions of these networks may be wireless through the use of wireless technologies such as a technology commonly known as “WiFi” which is currently specified by the IEEE as 802.11 and its various variants which are typically alphabetically designated as 802.11a, 802.11b, 802.11g and 802.11n to name a few.

Portions of a network may additionally include wireless networks that are typically designated as “cellular networks”. In many of these networks, Internet traffic is routed through high-speed “packet-switched” or “circuit-switched” data channels that may be associated to traditional voice channels. In these networks 10, electronic devices 20, may include cell-phones, PDA's laptop computers, or other types of portable electronic devices. Additionally, metropolitan area networks may include “WiMax” networks employing an alternate wide area, or metropolitan area wireless technology. Further personal area networks are known in the art. Many of these personal area networks employ a frequency-hopping wireless technology known in the industry as “Bluetooth” others personal area networks may employ a technology known as Ultra-Wideband (UWB). The hallmark of personal area networks is their limited range, and in some instances very high data rates. Since many types of networks and underlying communication technologies are known in the art, various embodiments of the present invention will not therefore be limited with respect to the type of network or the underlying communication technology.

For purposes of clarity the term network as used herein specifically includes but is not limited to the following networks: a wireless communication network, a local area network, a wide area network, a client-server network, a peer-to-peer network, a wireless local area network, a wireless wide area network, a cellular network, a public switched telephone network, and the Internet.

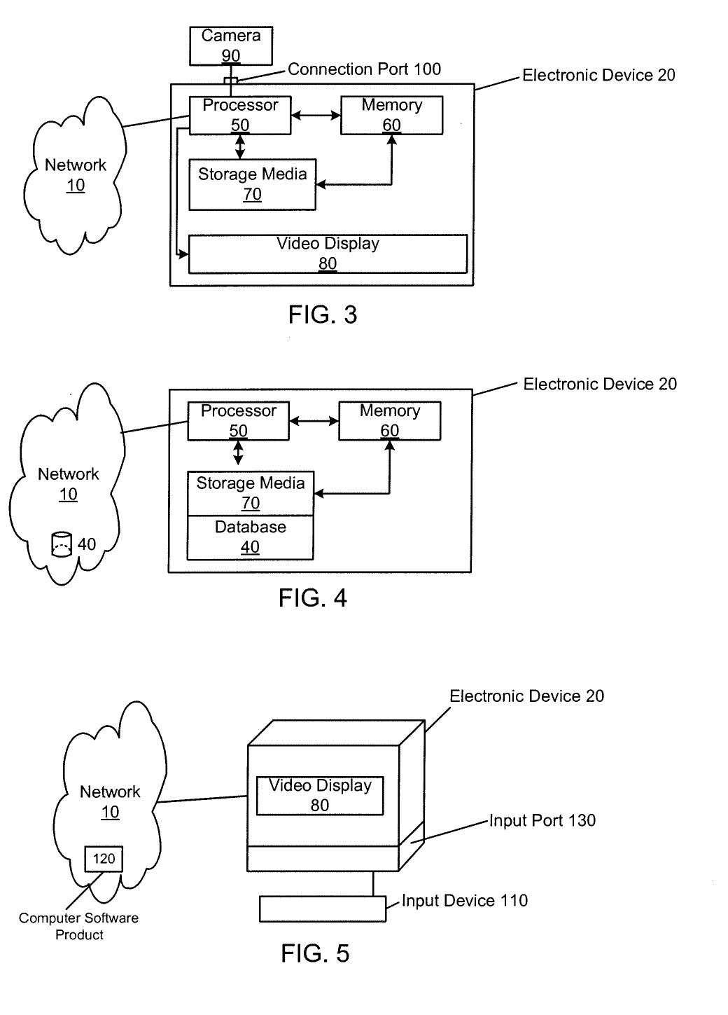

FIG. 3 illustrates a block diagram of an electronic device 20 consistent with provided embodiments. Electronic device 20 is suitable for connection to network 10. In wireless networks 10 this connection is through an antenna (not illustrated). In some embodiments, electronic device 20 comprises a processor 50, a memory 60, a storage media 70, a video display 80, and a connection port 100 suitable for connecting a camera 90 to electronic device 20. As is known in the art, electronic device 20 may comprise additional components (not illustrated for convenience). Processor 50 may comprise any general purpose processor or in some embodiments, may be an application specific processor or even a digital signal processor. A number of memory technologies are known in the art and may be used to practice the current invention, therefore embodiments are not limited by the specific memory 60 used. In some embodiments, the video display 80 may be integrated into the electronic device (as illustrated), in other embodiments, video display 80 may be external and connected to the electronic device through a connection port such as a Digital Visual Interface (DVI), a High Definition Multimedia Interface (HDMI), a serial port, a parallel port, a S-Video port, a coaxial cable, a twisted pair connection port, or other port suitable for connecting video display 80 to electronic device 20. In an exemplary embodiment, connection port 100 is a Universal Serial Bus (USB) connection.

Like the above ports, there are various technologies that may be used to connect camera 90 to electronic device 20. Another exemplary connection technology includes a wireless personal area network technology like Bluetooth or UWB. When this technology is used to connect camera 90 to electronic device 20 connection port 100 comprises an antenna and transceiver. In some embodiments, storage media 70 is a hard-drive. Since other storage media 70, such as chip based media, are known in the art, the various embodiments are not limited with respect to the particular storage media technology employed. In some embodiments, storage media 70 contains a set of machine executable instructions that when executed by processor 50 configures electronic device 20 to provide improved video-centric communications across network 10. These video-centric communications consistent with various provided methods described below.

As used herein, electronic device 20 may comprise any electronic device capable of executing the provided configuration and methods for video communications. Specific electronic devices 20 may include but are not limited to a computer, a laptop computer, a desktop computer, a portable electronic device, and a personal digital assistant.

FIG. 4 further illustrates another embodiment of a provided electronic device 20. In this embodiment, electronic device 20 is capable of connecting to network 10 in a similar manner as described above. Electronic device 20 comprises a processor 50, a memory 60 a storage media 70. Like the above embodiments, electronic device 20 may include additional components which are not illustrated for convenience. Processor 50 may comprise any general purpose processor or in some embodiments, may be an application specific processor or even a digital signal processor. A number of memory technologies are known in the art and may be used to practice the current invention, therefore embodiments are not limited by the specific memory 60 used. In one embodiment, electronic device 20 is a server 30 and network 10 is a client-server network. In this embodiment, storage media may further include a database where video and associated files may be stored and associated with each other. As discussed above, in some embodiments database 40 is located within electronic device 20, or server 30, or may be located on another device on network 10. When configured as a server 30, electronic device 20 may or may not include a video display 80. Like the above embodiments, storage media 70 contains a set of machine executable instructions that when executed by processor 50 configures electronic device 20, or in some embodiments, server 30 to provide video communications across network 10. These video-centric communications consistent with various provided methods described below.

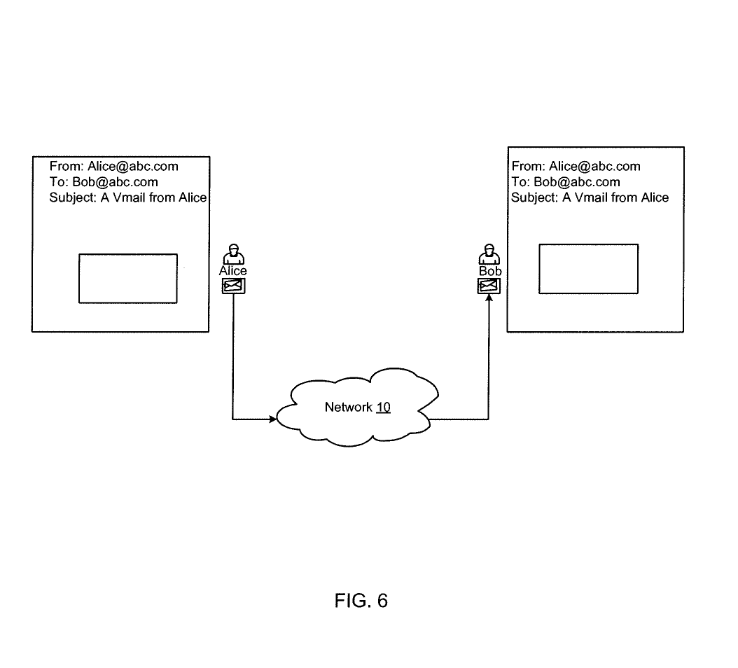

FIG. 5 illustrates another embodiment of electronic device 20 and an embodiment of a computer software product 120. In this embodiment, electronic device 20 is similar, in some respects, to the above embodiments but additionally includes an input device 110. In one embodiment electronic device 20 additionally includes an input port 120 suitable for accepting a computer software product 120. As is known in the art, input port 130 may be a port for a removable hard drive, a floppy disk port, an optical disk port, a port suitable to accept a computer software product 120 that comprises a chip based memory, or other port sufficient to accept computer software product 120. In another embodiment (not shown) electronic device does not include input port 130 and computer software product 120 may comprise a storage media, like a hard drive, located in a device on network 10.

In one embodiment of computer software product 120, a storage media 70 contains a set of computer executable instructions that, when executed by a processor 50, configure electronic device 20 to provide video communications across network 10. These video-centric communications consistent with various provided methods described below.

One feature of the present invention is illustrated in FIG. 6. In this illustration a first user “Alice” uses an electronic device 20 to send a v-mail to a second user “Bob”. as used herein the term “v-mail” refers to video-centric communications consistent with the provided embodiments. This illustration shows a video stream initiated by Alice on an electronic device 20 traversing a network 10, such as the Internet, being displayed on a second electronic device 20 owned by Bob.

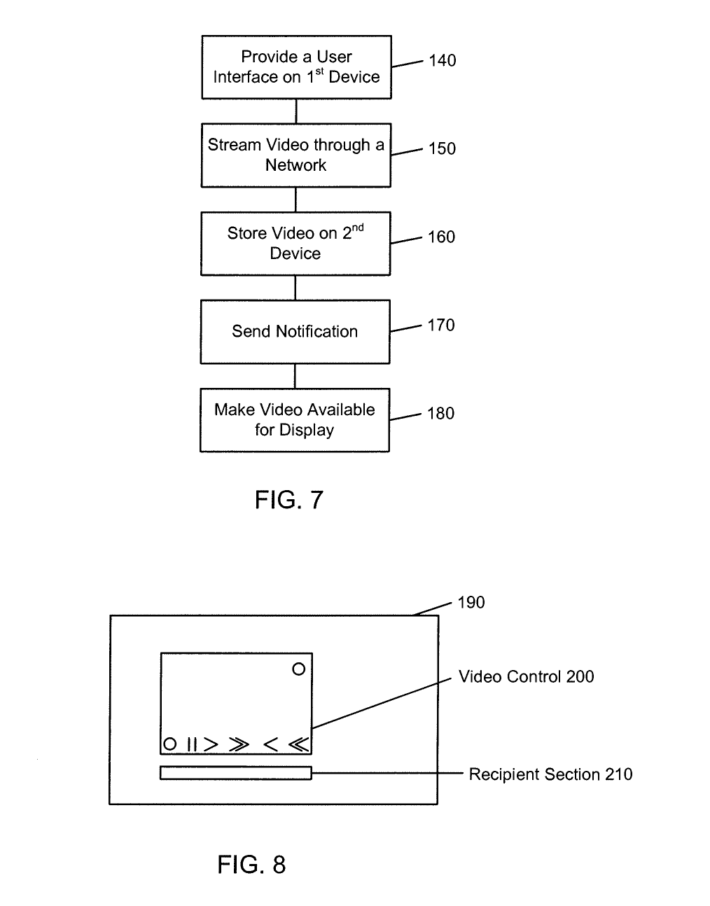

Various embodiments of provided methods are now discussed with reference to FIGS. 7-16. The configuration of an electronic device 20 for enhanced video communications begins in block 140 where a graphical user interface is provided on a first electronic device 20. An exemplary graphical user interface is illustrated in FIG. 8. The graphical user interface 190 may contain additional controls and sections but at a minimum contains a video control interface 200 and a recipient section 210. Exemplary controls within video control section may include record, stop, play, fast-forward, reverse, and fast reverse. Video control section allows a user to stream video from an electronic device 20 to a second electronic device 20 on network 10. As discussed above, second electronic device 20 may be a server 30. Recipient section 210 may comprise a text input box allowing a user to type a recipients address or other unique identifier such as a screen-name. In another embodiment, recipient section may include a selection window allowing a user to select receipient(s) from an address book.

Returning to FIG. 7, responsive to the appropriate video control, video is streamed to a second electronic device 20, such as a server 30, across network 10. One feature of this embodiment is that the video may be streamed to the second electronic device 20 without storage of the video on the first electronic device 20. In many situations, when the first electronic device 20 has limited storage capability this ability to stream video rather than record, locally save, then transfer is significantly advantageous. One example of this advantage is when the first electronic device is a cell phone or Personal Digital Assistant (PDA) with limited storage capacity. Flow continues to block 160 where the video is stored on the second device.

Another advantage of this embodiment is that it provides for a more persistent record of the communications since the video message is stored on the second device 20 and may be later retrieved. Flow continues to block 170 where the second electronic device 20 sends a notification that the video has been stored. In one embodiment, this notification is sent to the originator and the intended receipient(s). In another embodiment, this notification is sent only to the intended recipient(s). Various notification methods, such as text-message, simple message service, recorded phone call, fax, or email are known in the art. Various embodiments, are not therefore limited by the specific notification methodology. Flow then continues to block 180 where the video is made available for viewing by the recipient(s).

One feature of the present invention is that a user is notified of a video communication which they can view on an electronic device 20. In various embodiments the video may be streamed to the recipient's electronic device 20 or may be transferred as a file to the recipient's electronic device 20. One advantage of the present invention is that in some embodiments, a user may select to view a video as a stream when they are using an electronic device 20 with limited storage media 70, and may select to transfer the video as a file when using another electronic device 20 with more modest storage media 70. Since the second electronic device 20 stores the incoming video, it is available for viewing or downloading at a later time by the intended recipient.

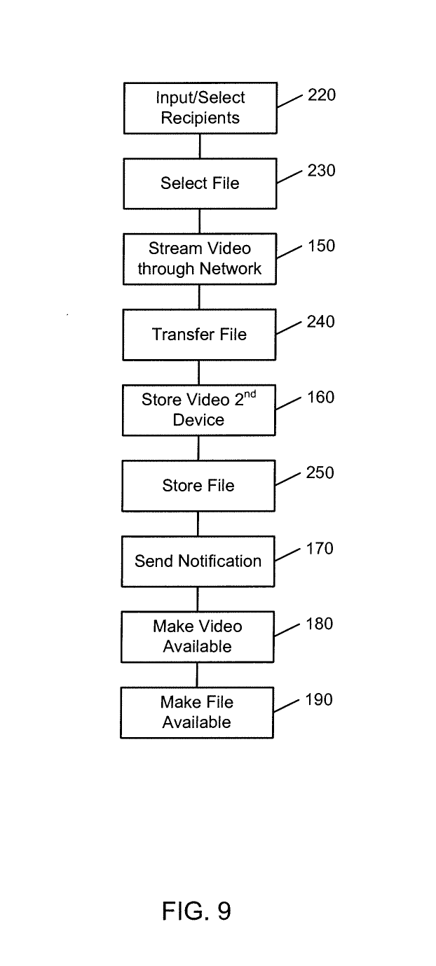

FIG. 9 illustrates another provided method for enhanced video communications. In this embodiment, recipients are selected or input in block 220. A file is associated with the video in block 230. In block 150 video is streamed to a second electronic device 20 on network 10. In block 240 the selected file is transferred to the second electronic device 20. In blocks 160 and 250 the video and the file are stored on the second electronic device 20. Like the above embodiment a notification is sent in block 170, and in blocks 180 and 190 the video and the file are made available to the recipient(s). The order of operation of many of the blocks described is not necessarily fixed. By way of example and not limitation, a file may be selected before recipients. A graphical user interface 190 consistent with this embodiment is illustrated in FIG. 10. This embodiment of a graphical user interface 190 is similar to the above embodiment with the addition of a control to associate a file with the video (depicted here as file selection control 260.) As used herein a file may comprise any form of electronic file such as a multi-media file; a voice recording; a video recording; a word processing file; an electronic photograph; a graphic file, and a drawing. In an exemplary embodiment, the user interface additionally contains a record audio control 270, where a user may record an audio file to be associated with the video. In a still further embodiment, illustrated in FIG. 10, the graphical user interface 190 may contain an optional play audio control 280 where the recorded audio file may be previewed before sending and where a received audio file may be selected for playback through speakers on the electronic device 20.

In embodiments where the second electronic device 20 is a server 30, the server 30 may associate the file to the video through the use of a database 40 located on the server. In other embodiments, the database may be located on another electronic device 20 on the network.

In some embodiments, the graphical user interface 190 includes a privacy control (not shown). In an exemplary embodiment, the privacy control may prevent viewing of video and opening of associated files by users other than the initial intended recipients. For example, if a user selects the privacy option when streaming video to a list of recipients and an intended recipient forwards the video to a user not on the initial recipient list, the privacy control may prevent their electronic device from playing back the video or in some instances, opening files associated with the video. In another embodiment, the privacy control acts as an access control on the second device. In this embodiment, when a video is made available to the recipients, all other users are restricted from transferring or initiating streaming of the video.

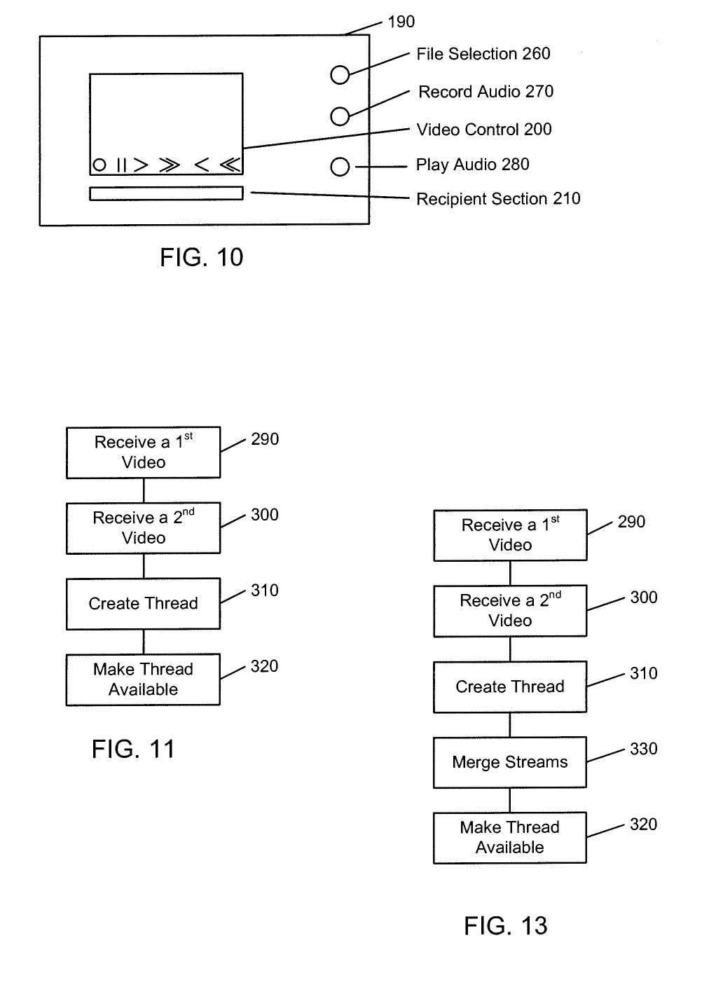

FIG. 11 illustrates another method consistent with various provided embodiments. A second electronic device 20, such as a server 30, receives and stores a first video message in block 290. The video message having a sender and recipients(s), and as discussed above may have files, audio, and text associated with the video. In block 300 a second video message is received by the second electronic device 20. The second electronic device 20 then associates the first and second messages, files and text if present to a thread in block 300. This thread then becomes part of a persistent history of communications between the users. In block 320 portions of the thread are made available to the various recipients.

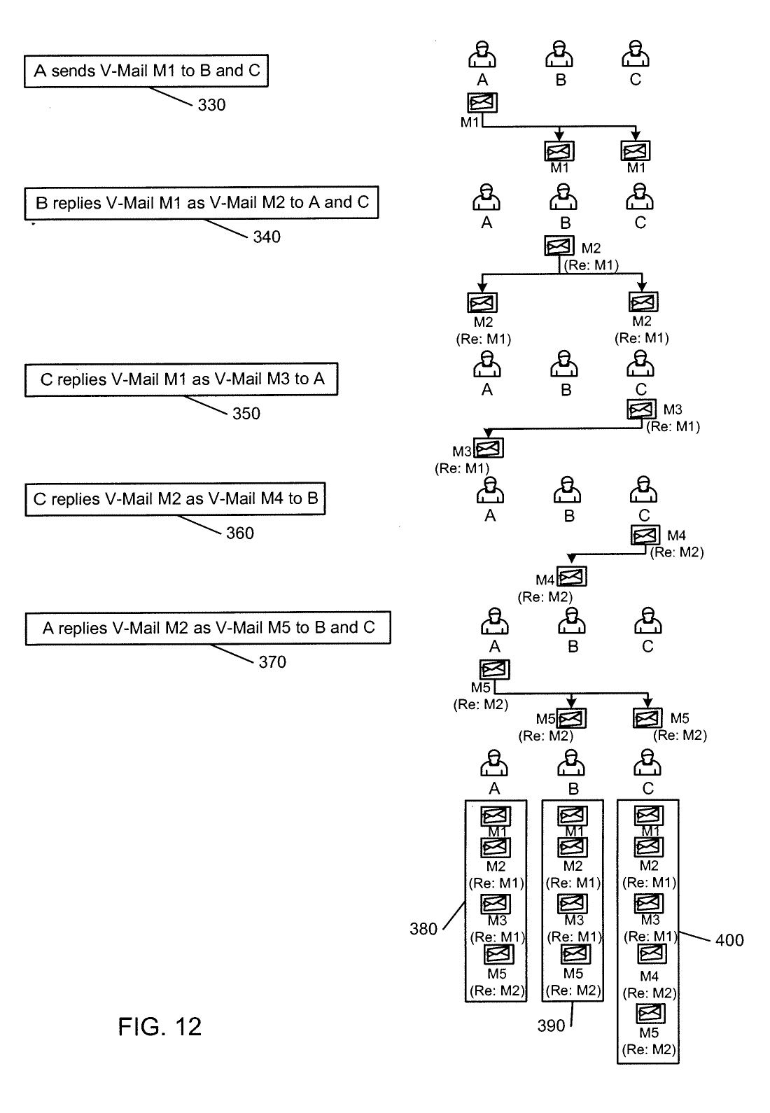

By way of example and not limitation, as illustrated in FIG. 12, in block 330 user A sends a video-mail “v-mail” M1 to users B and C. In block 340, user B replies to v-mail M1 by sending v-mail M2 to both A and C. In block 350 user C replies to the first v-mail M1 by sending v-mail M3 only to user A. In block 360 user C replies to v-mail M2 by sending v-mail M4 only to user B. In block 370 user A responds to v-mail M2 by sending v-mail M5 to both user B and user C. In this example, the second electronic device may create a number of threads. As shown thread 380 is associated to user A and references v-mail M1, M2, M3, and M5 since user A was not a recipient of v-mail M4. Thread 390 is associated to user B and contains v-mail M1, M2, M4, and M5 since user B was not a recipient of v-mail M3. In like manner, thread 400 is associated to user C and would contain all v-mail messages in the exchange. In an embodiment without a privacy control or where it was not selected, user C may forward v-mail M3 to user B, where it would be added to thread 390 and user B would have access to its contents. In an embodiment where v-mail M3 was sent by user C to user A with a privacy control selected, user B would not have access to the v-mail even if forwarded to them by user A.

Another embodiment is illustrated in FIG. 13. This embodiment is similar in many respects to the above embodiment where is begins in block 290 where the second electronic device 20 receives a first video stream and in block 300 receives a second video stream. Flow continues to block 310 where a thread is created. In this embodiment, the video streams are merged in block 330, and the thread is made available in block 320. The merger of video streams, as used herein, may consist of associating the streams for sequential playback, or it may involve rendering the contents of the video streams into a single video file. In some embodiments, advertising content may be added to the video streams. In one exemplary embodiment containing advertising content, the additional content is superimposed within a video stream as an additional frame or sequential frames within the video. In another embodiment, the advertising content comprises an additional video that is played between the content of sequential v-mail messages within a thread. In a still further embodiment, the advertising content comprises a logo or other image overlaid onto a portion of a frame or frames of the video message.

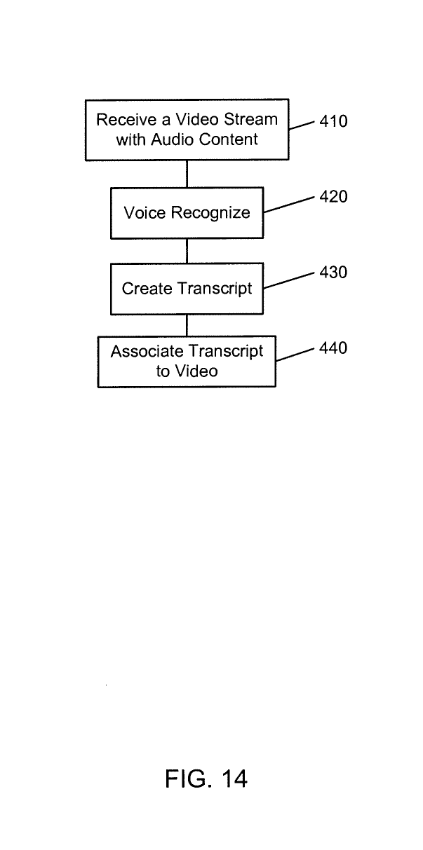

In another embodiment, illustrated in FIG. 14, a transcript of audio content from a video stream or other file containing audio is provided. Without loss of generality this embodiment is presented by using a video stream as an exemplar it is equally applicable to any content containing audio. In this embodiment, an electronic device 20 receives a video stream with audio content in block 410. In block 420 voice recognition technology is used to recognize the contents of the audio. Voice recognition technology is known in the art, the details of which are omitted for convenience. In block 430 a transcript of the audio content is created, and in block 440 the transcript is associated with the v-mail content it came from.

In another embodiment of a method for video based communication. The user interface contains the ability to display a thread in graphical form (see e.g. FIG. 12). In this embodiment, the graphical user interface includes a control that allows a user to select a portion of the thread to forward to other users.

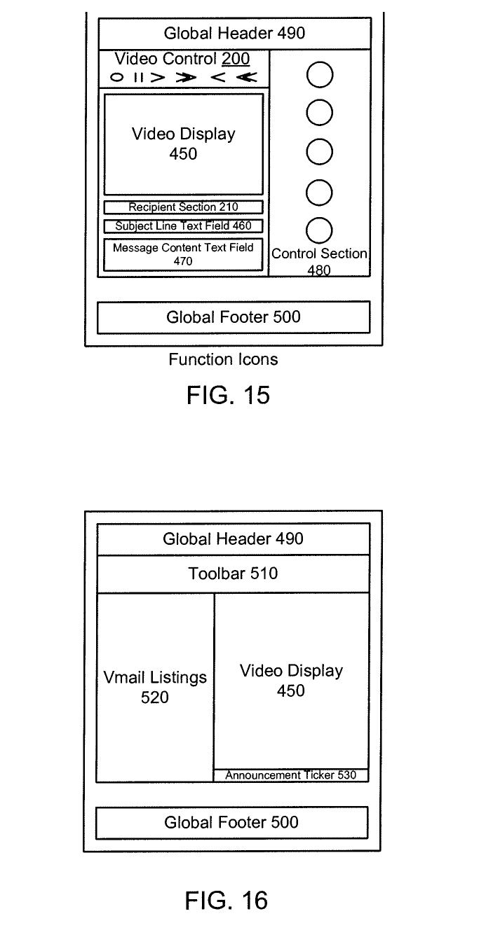

Additional functionality that a user interface 190 may optionally provide is illustrated in FIG. 15. In one embodiment, the user interface is configured to provide a video control section 200, a separate video display section 450, a recipient section 210, a subject field 460 where a user may enter a subject line, a message content text field 470 where text messages may be entered or displayed, a control section 480, a global header section 490 and a global footer section 500. The global header 490 and global footer section 500, in some embodiments, is used to display additional advertising content. Video display 450 is used to display video content and in some embodiments also is configured to graphically display threads. Control section 200 may include controls for file selection, recording audio files, playing audio files, and a privacy setting control as discussed above. It may additionally include controls for selecting a portion of a thread, forwarding a thread or a selected portion, and enabling a text input section. Further input sections (not illustrated) may include a carbon-copy section where a user can input or select recipients to cc, and a blind carbon copy section where a user can input or select recipients to bcc. It is important to note the placement of controls, inputs, and displays on a graphical user interface may take many forms. The invention is therefore not limited with respect to any specific arrangement or placement.

Another embodiment of a graphical user interface is illustrated in FIG. 16. In this embodiment, a global header 490, global footer 500, and video display 450 are provided and function similarly to the above embodiment. One distinction with video display 450 is that it is configured to provide a set of pup-up menus which can include such menu items as “View Video Mail”, “Record Video”, “Display Advertisement Video”, “Initiate Live Video Conference”, and “Video Clip Browsing” to name a few. In this embodiment toolbar 510 contains the above mentioned controls. V-mail listings section 520 in one embodiment, comprises an “In-box” where notifications are received. In other embodiments (not shown) V-mail listing section 520 may be configured to display a graphical representation of a thread. In still further embodiments, V-mail listing section 520 comprises an address book where recipient selection is simplified. This embodiment of a graphical user interface 190 additionally includes an announcement ticker section 530 where text and/or images may be displayed or scrolled.

The present invention provides significant novel advantages over current forms of electronic communications. Thus, it is seen that a system, method and apparatus for video communications are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A method of facilitating video-based communications comprising:
providing a graphical user interface on a first electronic device, wherein the graphical user interface comprises a recipient section, and a video control interface;
streaming video from the first electronic device to a second electronic device on a network responsive to the video control interface and a video camera, the video camera being connected to the first electronic device;
storing the video on the second electronic device;
notifying a recipient that the video has been stored on the second electronic device; and
displaying the video on a third electronic device.

2. The method of claim 1, wherein the second electronic device is a server.

3. The method of claim 2, wherein the user interface further comprises a control for associating a file with the video, the method further comprising transferring the file from the first electronic device to the server and storing the file on the server.

4. The method of claim 3, further comprising transferring the file to the third electronic device.

5. The method of claim 3, wherein the file comprises a file selected from a group consisting of: a multi-media file; a voice recording; a video recording; a word processing file; an electronic photograph; a graphic file, and a drawing.

6. The method of claim 3, further comprising associating the file with the video through a database on the server.

7. The method of claim 2, wherein the user interface further comprises a control for associating an audio file with the video, the audio file being recorded from a microphone connected to the first electronic device, the method further comprising transferring the audio file from the first electronic device to the server and storing the audio file on the server.

8. The method of claim 7, transferring the audio file to the second electronic device.

9. The method of claim 7, further comprising associating the audio file to the video through a database on the server.

10. The method of claim 7, wherein the user interface further comprises a control allowing playback of the audio on the first electronic device prior to transferring the audio file to the server.

11. The method of claim 2, wherein the user interface further comprises a privacy control, the privacy control restricting the transfer of the video from the server.

12. The method of claim 11, wherein the privacy control restriction allows the video to be transferred from the server to a designated group of recipients.

13. The method of claim 2, wherein the user interface further comprises a privacy control, the privacy control permitting the display of the video on the third electronic device.

14. The method of claim 2, further comprising associating a plurality of video streams to a thread, the thread based on user actions.

15. The method of claim 14, wherein the user actions comprise actions selected from a group consisting of: replying to a video message, forwarding a video message, and replying to all recipients of a video message.

16. The method of claim 14, further comprising merging video streams associated to the thread.

17. The method of claim 16, wherein merging video streams comprises linking the video streams associated by the thread for sequential playback on the second electronic device.

18. The method of claim 16, wherein merging video streams comprises rendering the video content of the streams associated by the thread into a single video.

19. The method of claim 16, further comprising displaying the thread on the third electronic device.

20. The method of claim 2, further comprising displaying an advertisement on the third electronic device.

21. The method of claim 20, wherein the advertisement comprises a video displayed on the third electronic device.

22. The method of claim 20, wherein the advertisement comprises an image overlaid onto at least one frame of the video content.

23. The method of claim 20, wherein the advertisement comprises a logo superimposed onto a portion of at least one frame of the video content.

24. The method of claim 2, wherein the user interface further comprises a text input section, the method further comprising transferring the contents of the text input section to the server and displaying the contents of the text input section on the second electronic device.

25. The method of claim 2, further comprising
associating a plurality of video streams to a thread;
displaying the thread on the third electronic device, and
wherein the user interface further comprises a control for forwarding a selected portion of the thread to a fourth electronic device.

26. The method of claim 1, wherein the first, second, and third electronic devices comprise devices selected from a group consisting of: a computer, a laptop computer, a desktop computer, a portable electronic device, and a personal digital assistant.

27. The method of claim 1, wherein the network comprises a network selected from a group consisting of: a wireless communication network, a local area network, a wide area network, a client-server network, a peer-to-peer network, a wireless local area network, a wireless wide area network, a cellular network, a public switched telephone network, and the internet.

28. The method of claim 1, wherein the user interface comprises a browser based user interface.

29. The method of claim 1, wherein the user interface comprises a user interface generated independent of a web-browser.

30. The method of claim 1, wherein the user interface comprises an input section selected from a group consisting of: a subject section, a carbon-copy section, a blind carbon-copy section.

31. The method of claim 1, wherein the user interface comprises a control selected from a group consisting of: a reply control, a reply-to-all control, and a forward control.

32. An electronic device comprising:
a processor;
a memory;
a video camera;
a video display; and
a storage media, the storage media comprising a set of executable instructions, the machine executable instructions comprising a configuration for controlling the electronic device to display a graphical user interface on the video display, wherein the graphical user interface comprises a recipient section and a video control interface, the executable instructions further comprising a configuration to stream video from the electronic device to a second electronic device on a network responsive to the video control interface and the video camera, the configuration further comprising a configuration to receive notification that a video has been stored on the second electronic device and display the stored video on the video display.

33. The electronic device of claim 32, wherein the second electronic device is a server.

34. The electronic device of claim 33, wherein the user interface further comprises a control for associating a file with the video, the configuration further comprising a configuration to transfer the file from the electronic device to the server.

35. The electronic device of claim 33, wherein the configuration further comprises a configuration to receive a file from the server.

36. The electronic device of claim 34, wherein the file comprises a file selected from a group consisting of: a multi-media file; a voice recording; a video recording; a word processing file; an electronic photograph; a graphic file, and a drawing.

37. The electronic device of claim 34, wherein the file is associated with the video through a database on the server.

38. The electronic device of claim 33, wherein the user interface further comprises a control for associating an audio file with the video, the audio file being recorded from a microphone connected to the electronic device, the configuration further comprising a configuration to transfer the audio file from the electronic device to the server.

39. The electronic device of claim 38, wherein the audio file is associated with the video through a database on the server.

40. The electronic device of claim 33, wherein the configuration further comprises a configuration to receive an audio file from the server.

41. The electronic device of claim 33, wherein the electronic device further comprises a speaker, the user interface further comprises a control allowing playback of audio on the speaker.

42. The electronic device of claim 33, wherein the user interface further comprises a privacy control, the privacy control restricting the transfer of the video from the server.

43. The electronic device of claim 42, wherein the privacy control restriction allows the video to be transferred from the server to a designated group of recipients.

44. The electronic device of claim 42, wherein the user interface further comprises a privacy control, the privacy control permitting the display of the video.

45. The electronic device of claim 33, wherein the server associates a plurality of video streams to a thread, the thread based on user actions.

46. The electronic device of claim 45, wherein the user actions comprise actions selected from a group consisting of: replying to a video message, forwarding a video message, and replying to all recipients of a video message.

47. The electronic device of claim 45, wherein the server merges video streams associated to the thread.

48. The electronic device of claim 47, wherein merging video streams comprises linking the video streams associated by the thread for sequential playback on an electronic device.

49. The electronic device of claim 47, wherein merging video streams comprises rendering the video content of the streams associated by the thread into a single video.

50. The electronic device of claim 45, wherein the graphical user interface is further configured to displaying the thread on the video display.

51. The electronic device of claim 33, wherein the graphical user interface is further configured to display an advertisement on the video display.

52. The electronic device of claim 51, wherein the advertisement comprises a video.

53. The electronic device of claim 51, wherein the advertisement comprises an image overlaid onto at least one frame of the video content.

54. The electronic device of claim 51, wherein the advertisement comprises a logo superimposed onto a portion of at least one frame of the video content.

55. The electronic device of claim 33, wherein the user interface further comprises a text input section, the configuration further comprising a configuration to transfer the contents of the text input section to the server and displaying the contents of a text input section on the video display.

56. The electronic device of claim 33, wherein a plurality of video streams are associated to a thread on the server, the configuration further comprising a configuration to display a thread on the video display, the user interface further comprising a control for forwarding a portion of the thread to another electronic device.

57. The electronic device of claim 32, wherein the electronic device comprises a device selected from a group consisting of: a computer, a laptop computer, a desktop computer, a portable electronic device, and a personal digital assistant.

58. The electronic device of claim 32, wherein the network comprises a network selected from a group consisting of: a wireless communication network, a local area network, a wide area network, a wireless local area network, a client-server network, a peer-to-peer network, a wireless wide area network, a cellular network, a public switched telephone network, and the internet.

59. The electronic device of claim 32, wherein the user interface comprises a browser based user interface.

60. The electronic device of claim 32, wherein the user interface comprises a user interface generated independent of a web-browser.

61. The electronic device of claim 32, wherein the user interface comprises an input section selected from a group consisting of: a subject section, a carbon-copy section, a blind carbon-copy section.

62. The electronic device of claim 32, wherein the user interface comprises a control selected from a group consisting of: a reply control, a reply-to-all control, and a forward control.

63. An server device comprising
a processor;
a memory; and
a storage media, the storage media comprising a set of executable instructions, the machine executable instructions comprising a configuration for controlling the server to receive a video stream and store the video stream on the storage media, the video stream originating from an electronic device on a network, the electronic device configured to display a graphical user interface on a video display, wherein the graphical user interface comprises a recipient section and a video control interface, electronic device being configured to stream video from server responsive to the video control interface and a video camera, the server being further configured to notify a recipient that the video has been stored on the server.

64. The server device of claim 63, wherein the user interface further comprises a control for associating a file with the video, the server configuration further comprises a configuration to receive the file from the electronic device and store the file on the server.

65. The server device of claim 64, wherein the file comprises a file selected from a group consisting of: a multi-media file; a voice recording; a video recording; a word processing file; an electronic photograph; a graphic file, and a drawing.

66. The server device of claim 64, wherein the server configuration further comprises a configuration to associate the file with the video through a database.

67. The server device of claim 66, wherein the database is located externally to the server on the network.

68. The server device of claim 63, wherein the user interface further comprises a control for associating an audio file with the video, the audio file being recorded from a microphone connected to the electronic device, the server configuration further comprising receiving the audio file from the electronic device and storing the audio file.

69. The server device of claim 68, wherein the server configuration further comprises a configuration to associate the audio file to the video through a database.

70. The server device of claim 69, wherein the database is located externally to the server on the network.

71. The server device of claim 63, wherein the user interface further comprises a control allowing playback of audio on the electronic device.

72. The server device of claim 63, wherein the user interface further comprises a privacy control, the server configuration further comprising a configuration to restrict the transfer of the video from the server.

73. The server device of claim 72, wherein the privacy control restriction allows the video to be transferred from the server to a designated group of recipients.

74. The server device of claim 63, wherein the user interface further comprises a privacy control, the server configuration further comprising a configuration to allow the display of the video based on the privacy control.

75. The server device of claim 63, wherein the server configuration further comprises a configuration for associating a plurality of video streams to a thread, the thread based on user actions.

76. The server device of claim 75, wherein the user actions comprise actions selected from a group consisting of: replying to a video message, forwarding a video message, and replying to all recipients of a video message.

77. The server device of claim 75, wherein the server configuration further comprises a configuration for merging video streams associated to the thread.

78. The server device of claim 77, wherein the server configuration for merging comprises a configuration to link the video streams associated by the thread for sequential playback on an electronic device.

79. The server device of claim 77, wherein the server configuration for merging comprises a configuration to render the video content of the streams associated by the thread into a single video.

80. The server device of claim 75, wherein the server configuration further comprises a configuration to transfer the thread to an electronic device.

81. The server device of claim 63, wherein the server configuration further comprises a configuration to transmit an advertisement to an electronic device.

82. The server device of claim 81, wherein the advertisement comprises an image overlaid onto at least one frame of the video content.

83. The server device of claim 81, wherein the advertisement comprises a logo superimposed onto a portion of at least one frame of the video content.

84. The server device of claim 63, wherein the user interface further comprises a text input section, the server configuration further comprising a configuration to receive the contents of the text input section from an electronic device and store the contents of the text input section on the server.

85. The server device of claim 63, wherein the server configuration further comprises a configuration to associate a plurality of video streams to a thread and transfer the thread to an electronic device, the graphical user interface further comprising a control for forwarding a portion of the thread to another electronic device.

86. The server device of claim 63, wherein the electronic device and the server device comprise devices selected from a group consisting of: a computer, a laptop computer, a desktop computer, a portable electronic device, and a personal digital assistant.

87. The server device of claim 63, wherein the network comprises a network selected from a group consisting of: a wireless communication network, a local area network, a wide area network, a wireless local area network, a client-server network, a peer-to-peer network, a wireless wide area network, a cellular network, a public switched telephone network, and the internet.

88. The server device of claim 63, wherein the user interface comprises a browser based user interface.

89. The server device of claim 63, wherein the user interface comprises a user interface generated independent of a web-browser.

90. The server device of claim 63, wherein the user interface comprises an input section selected from a group consisting of: a subject section, a carbon-copy section, a blind carbon-copy section.

91. The server device of claim 63, wherein the user interface comprises a control selected from a group consisting of: a reply control, a reply-to-all control, and a forward control.

92. A computer software product comprising
a physical storage media comprising a set of computer executable instructions, the instructions capable of configuring a computer to
provide a graphical user interface on a first electronic device, wherein the graphical user interface comprises a recipient selection section, and a video control interface;
stream video from the first electronic device to a second electronic device on a network responsive to the video control interface and a video camera, the video camera being connected to the first electronic device, wherein the video is stored on the second electronic device and a recipient is notified that the video has been stored; and
displaying the video on a video display.

93. The computer software product of claim 92, wherein the second electronic device is a server.

94. The computer software product of claim 93, wherein the user interface further comprises a control for associating a file with the video, the configuration further comprising a configuration to transfer the file from the first electronic device to the server.

95. The computer software product of claim 94, wherein the server is configured to transfer the file to a third electronic device.

96. The computer software product of claim 94, wherein the file comprises a file selected from a group consisting of: a multi-media file; a voice recording; a video recording; a word processing file; an electronic photograph; a graphic file, and a drawing.

97. The computer software product of claim 93, wherein the server is configured to associate the file with the video through a database.

98. The computer software product of claim 97, wherein the database is located externally to the server on the network.

99. The computer software product of claim 93, wherein the user interface further comprises a control for associating an audio file with the video, the audio file being recorded from a microphone connected to the first electronic device, the configuration further comprising a configuration to transfer the audio file from the first electronic device to the server.

100. The computer software product of claim 99, wherein the server is further configured to transfer the audio file an electronic device.

101. The computer software product of claim 99, wherein the server is further configured to associate the audio file to the video through a database.

102. The computer software product of claim 101, wherein the database is located externally to the server on the network.

103. The computer software product of claim 99, wherein the user interface further comprises a control allowing playback of the audio on the first electronic device prior to transferring the audio file to the server.

104. The computer software product of claim 93, wherein the user interface further comprises a privacy control, the privacy control restricting the transfer of the video from the server.

105. The computer software product of claim 104, wherein the privacy control restriction allows the video to be transferred from the server to a designated group of recipients.

106. The computer software product of claim 93 wherein the user interface further comprises a privacy control, the privacy control allowing the display of the video on an electronic device.

107. The computer software product of claim 93, wherein the server is configured to associate a plurality of video streams to a thread, the thread based on user actions.

108. The computer software product of claim 107, wherein the user actions comprise actions selected from a group consisting of: replying to a video message, forwarding a video message, and replying to all recipients of a video message.

109. The computer software product of claim 107, wherein the server is further configured to merge video streams associated to the thread.

110. The computer software product of claim 109, wherein the configuration for merging video streams comprises a configuration to link the video streams associated by the thread for sequential playback on the video display.

111. The computer software product of claim 109, wherein the configuration for merging video streams comprises a configuration to render the video content of the streams associated by the thread into a single video.

112. The computer software product of claim 107, wherein the server is further configured to transfer the thread to an electronic device on the network.

113. The computer software product of claim 93, wherein the server is configured to transfer an advertisement to an electronic device on the server.

114. The computer software product of claim 113, wherein the advertisement comprises a video.

115. The computer software product of claim 114, wherein the advertisement comprises an image overlaid onto at least one frame of the video content.

116. The computer software product of claim 114, wherein the advertisement comprises a logo superimposed onto a portion of at least one frame of the video content.

117. The computer software product of claim 93, wherein the user interface further comprises a text input section, the server configuration further comprising a configuration to receive the contents of the text input section from an electronic device and transfer the contents of the text input section on the another electronic device on the network.

118. The computer software product of claim 93, wherein the server configuration further comprises a configuration to associate a plurality of video streams to a thread and transfer the thread to a third electronic device, and
wherein the user interface further comprises a control for forwarding a portion of the thread to a fourth electronic device.

119. The computer software product of claim 92, wherein the first, second, and third electronic devices comprise devices selected from a group consisting of: a computer, a laptop computer, a desktop computer, a portable electronic device, and a personal digital assistant.

120. The computer software product of claim 92, wherein the network comprises a network selected from a group consisting of: a wireless communication network, a local area network, a wide area network, a wireless local area network, a client-server network, a peer-to-peer network, a wireless wide area network, a cellular network, a public switched telephone network, and the internet.

121. The computer software product of claim 92, wherein the user interface comprises a browser based user interface.

122. The computer software product of claim 92, wherein the user interface comprises a user interface generated by a stand-alone software application.

123. The computer software product of claim 92, wherein the user interface comprises an input section selected from a group consisting of: a subject section, a carbon-copy section, a blind carbon-copy section.

124. The computer software product of claim 92, wherein the user interface comprises a control selected from a group consisting of: a reply control, a reply-to-all control, and a forward control.
